(19) United States
(12) Patent Application Publication
(10) Pub. No.: US 2023/0009173 A1
(43) Pub. Date: Jan. 12, 2023

(54) LANE CHANGE NEGOTIATION METHODS AND SYSTEMS

(71) Applicant: GM GLOBAL TECHNOLOGY OPERATIONS LLC, Detroit, MI (US)

(72) Inventor: Roi Reshef, Herzilya (IL)

(73) Assignee: GM GLOBAL TECHNOLOGY OPERATIONS LLC, Detroit, MI (US)

(21) Appl. No.: 17/305,619

(22) Filed: Jul. 12, 2021

(51) Int. Cl. B60W 30/18; B60W 60/00; B60W 30/095; B60W 30/16; B60W 50/00; B60W 40/04; B60W 40/12

(52) U.S. Cl. CPC B60W 30/18163; B60W 60/00274; B60W 60/0015; B60W 30/0956; B60W 30/16; B60W 50/0097; B60W 40/04; B60W 40/12; B60W 2050/0016; B60W 2554/80

(57) ABSTRACT

In various embodiments, methods, systems, and vehicles are provided for executing a lane change for a host vehicle. In various embodiments, a method includes: receiving, by a processor, an indication that a lane change from an initial lane to an intended lane is desired for the host vehicle; defining, by the processor, an initial lane center target, a negotiation target, and an intended lane center target based on the desired lane change; and controlling, by the processor, the host vehicle to at least one of the initial lane center target, the negotiation target, and the intended lane center target based on a finite state machine, wherein the initial lane center target is at or in proximity to a determined center of the initial lane, wherein the intended lane center target is at or in proximity to a determined center of the intended lane, and wherein the negotiation target is offset from the initial lane center target and within the initial lane.

### TECHNICAL FIELD

The present disclosure generally relates to vehicles, and more particularly relates to systems and methods for negotiating a lane change for an autonomous vehicle.

An autonomous vehicle is a vehicle that is capable of sensing its environment and navigating with little or no user input. It does so by using sensing devices such as radar, lidar, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle.

While autonomous vehicles offer many potential advantages over traditional vehicles, in certain circumstances it may be desirable for improved movement of autonomous vehicles. For example, autonomous vehicles perform lane changes to navigate to a next turn, to exit a highway, maneuver around other vehicles or object in the lane, or to increase speed. When the adjacent lane is heavily trafficked, the vehicle must “cut-in” to the adjacent lane, in between other vehicles. Accordingly, it is desirable to provide systems and methods for negotiating a lane change with the other vehicles before performing the cut-in lane change maneuver. Furthermore, other desirable features and characteristics of the present disclosure will become apparent from the subsequent detailed description and the appended claims, taken in conjunction with the accompanying drawings and the foregoing technical field and background.

### SUMMARY

In various embodiments, methods, systems, and vehicles are provided for executing a lane change for a host vehicle. In various embodiments, a method includes: receiving, by a processor, an indication that a lane change from an initial lane to an intended lane is desired for the host vehicle; defining, by the processor, an initial lane center target, a negotiation target, and an intended lane center target based on the desired lane change; and controlling, by the processor, the host vehicle to at least one of the initial lane center target, the negotiation target, and the intended lane center target based on a finite state machine, wherein the initial lane center target is at or in proximity to a determined center of the initial lane, wherein the intended lane center target is at or in proximity to a determined center of the intended lane, and wherein the negotiation target is offset from the initial lane center target and within the initial lane.

In various embodiments, the determining the negotiation target is based on sensor data received from sensors of the host vehicle.

In various embodiments, the determining the negotiation target is based on vehicle parameters defining the size of the host vehicle.

In various embodiments, the determining the negotiation target is based on a desired right lane change and a desired left lane change.

In various embodiments, the finite state machine includes at least three states, an initial lane centering state, a negotiation state, and an intended lane centering state, and wherein the method comprises: controlling, by the processor, the host vehicle to the initial lane center target when a current state is the initial lane centering state; controlling, by the processor, the host vehicle to the negotiation target when the current state is the negotiation state; and controlling, by the processor, the host vehicle to the intended lance center target when the current state is the intended lane centering state.

In various embodiments, the finite state machine includes a plurality of transitions, wherein at least one of the transitions is based on a safety distance associated with an other.

In various embodiments, the method includes determining the other vehicle to be within the initial lane and ahead of a position of the host vehicle.

In various embodiments, the method includes determining the other vehicle to be within the intended lane behind or at a position of the host vehicle.

In various embodiments, the method includes determining the other vehicle to be within the intended lane and ahead of a position of the host vehicle.

In various embodiments, the method includes computing the safety distance based on a predicted state of the other vehicle at a future time.

In various embodiments, the method includes computing the safety distance based on the predicted state of the other vehicle at the future time and until the future time is equal to a predicted time of cut-in to the intended lane.

In various embodiments, the method includes computing the safety distance based on a predicted time of cut-in to the intended lane, a predicted state of the host vehicle at the predicted time of cut-in, and a predicted state of the other vehicle at the predicted time of cut-in.

In another embodiment, a system for executing a lane change for a host vehicle includes: one or more sensors configured to obtain sensor data pertaining to a host vehicle and one or more other vehicles in proximity to the host vehicle; and a processor coupled to the one or more sensors. The processor is configured to: receive an indication that a lane change from an initial lane to an intended lane is desired for the host vehicle; define an initial lane center target, a negotiation target, and an intended lane center target based on the desired lane change; and control the host vehicle to at least one of the initial lane center target, the negotiation target, and the intended lane center target based on a finite state machine, wherein the initial lane center target is at or in proximity to a determined center of the initial lane, wherein the intended lane center target is at or in proximity to a determined center of the intended lane, and wherein the negotiation target is offset from the initial lane center target and within the initial lane.

In various embodiments, the negotiation target is determined based on at least one of the sensor data, vehicle parameters defining the size of the host vehicle, a desired right lane change and a desired left lane change.

In various embodiments, the finite state machine includes at least three states, an initial lane centering state, a negotiation state, and an intended lane centering state, and wherein when a current state is the initial lane centering state, the processor controls the host vehicle to the initial lane center target, wherein when the current state is the negotiation state, the processor controls the host vehicle to the negotiation target, and when the current state is the intended lane centering state, the processor controls the host vehicle to the intended lance center target.

In various embodiments, the finite state machine includes a plurality of transitions, wherein at least one of the transitions is based on a safety distance associated with an other.

In various embodiments, the processor is further configured to: compute the safety distance based on a predicted state of the other vehicle at a future time.

In various embodiments, the processor is further configured to: compute the safety distance based on the predicted state of the other vehicle at the future time and until the future time is equal to a predicted time of cut-in to the intended lane.

In various embodiments, the processor is further configured to: compute the safety distance based on a predicted time of cut-in to the intended lane, a predicted state of the host vehicle at the predicted time of cut-in, and a predicted state of the other vehicle at the predicted time of cut-in.

In yet another embodiment, an autonomous vehicle includes: one or more sensors configured to obtain sensor data pertaining to the autonomous vehicle and one or more other vehicles in proximity to the autonomous vehicle; and a processor coupled to the one or more sensors. The processor is configured to: receive an indication that a lane change from an initial lane to an intended lane is desired for the autonomous vehicle; define an initial lane center target, a negotiation target, and an intended lane center target based on the desired lane change; and control the autonomous vehicle to at least one of the initial lane center target, the negotiation target, and the intended lane center target based on a finite state machine, wherein the initial lane center target is at or in proximity to a determined center of the initial lane, wherein the intended lane center target is at or in proximity to a determined center of the intended lane, and wherein the negotiation target is offset from the initial lane center target and within the initial lane.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating a vehicle having a lane change negotiation system, in accordance with various embodiments;

FIG. 2 is functional block diagram illustrating an autonomous driving system (ADS) having a lane change negotiation system associated with the vehicle of FIG. 1, in accordance with various embodiments;

FIGS. 3A and 3B are illustrations of lanes and targets of the lane change negotiation system, in accordance with various embodiments;

FIG. 4. is a state transition diagram illustrating a negotiation system of the lane change negotiation system, in accordance with various embodiments;

FIGS. 5 and 6 are illustrations of lanes and safety measures computed by the lane change negotiation system, in accordance with various embodiments;

FIG. 7 is a flowchart illustrating a control process for negotiating a lane change for a vehicle, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

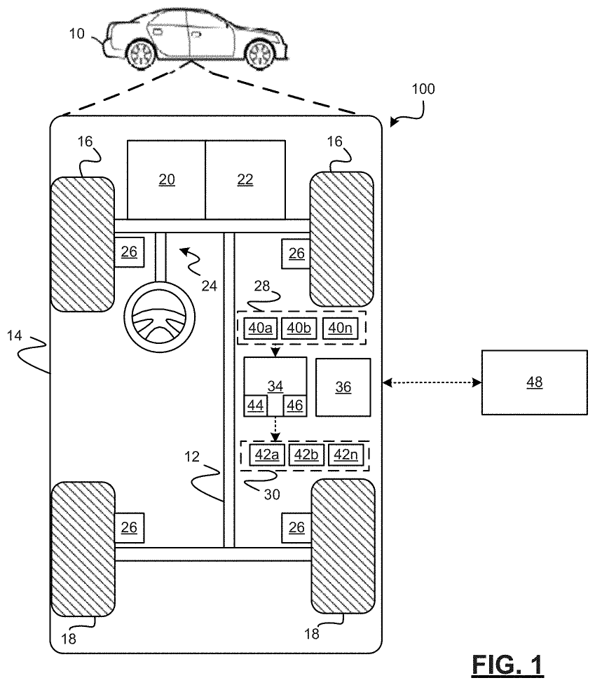

With reference to FIG. 1, a lane change negotiation system shown generally as 100 is associated with a vehicle 10 (also referred to herein as a “host vehicle”) in accordance with various embodiments. In general, the lane change negotiation system (or simply “system”) 100 provides for negotiation by the host vehicle of a lane change in front of a vehicle or between vehicles travelling in an adjacent lane. For example, in various embodiments, the vehicle 10 negotiates the lane change by travelling first at a lateral location that is offset from the lane center and then performing the lane change when it is determined safe to perform a cut-in maneuver. The vehicle determines when it is safe based on a proactive analysis of the vehicles in the current lane and the intended lane.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. In various embodiments, the wheels 16, 18 comprise a wheel assembly that also includes respective associated tires.

In various embodiments, the vehicle 10 is an autonomous vehicle, and the lane change planning system 100, and/or components thereof, are incorporated into the vehicle 10. The vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, and the like, can also be used.

In an exemplary embodiment, the vehicle 10 corresponds to a level two, level three, level four, or level five automation system under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level five system, on the other hand, indicates “full automation,” referring to a driving mode in which the automated driving system performs all aspects of the dynamic driving task under all roadway and environmental conditions that can be managed by a human driver. It will be appreciated, however, the embodiments in accordance with the present subject matter are not limited to any particular taxonomy or rubric of automation categories. Furthermore, systems in accordance with the present embodiment may be used in conjunction with any autonomous, non-autonomous, or other vehicle that includes sensors and a suspension system.

As shown, the vehicle 10 generally includes a propulsion system 20, a transmission system 22, a steering system 24, a brake system 26, one or more user input devices 27, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems. The steering system 24 influences a position of the vehicle wheels 16 and/or 18. While depicted as including a steering wheel for illustrative purposes, in some embodiments contemplated within the scope of the present disclosure, the steering system 24 may not include a steering wheel.

The sensor system 28 includes one or more sensors 40a-40n that sense observable conditions of the exterior environment and/or the interior environment of the vehicle 10. The sensors 40a-40n include, but are not limited to, radars, lidars, global positioning systems, optical cameras, thermal cameras, ultrasonic sensors, inertial measurement units, and/or other sensors.

The actuator system 30 includes one or more actuators 42a-42n that control one or more vehicle features such as, but not limited to, the propulsion system 20, the transmission system 22, the steering system 24, and the brake system 26. In various embodiments, vehicle 10 may also include interior and/or exterior vehicle features not illustrated in FIG. 1, such as various doors, a trunk, and cabin features such as air, music, lighting, touch-screen display components (such as those used in connection with navigation systems), and the like.

The data storage device 32 stores data for use in automatically controlling the vehicle 10. In various embodiments, the data storage device 32 stores defined maps of the navigable environment. In various embodiments, the defined maps may be predefined by and obtained from a remote system. For example, the defined maps may be assembled by the remote system and communicated to the vehicle 10 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location. As will be appreciated, the data storage device 32 may be part of the controller 34, separate from the controller 34, or part of the controller 34 and part of a separate system.

The communication system 36 is configured to wirelessly communicate information to and from other entities 48, such as but not limited to, other vehicles (“V2V” communication), infrastructure (“V2I” communication), remote transportation systems, and/or user devices. In an exemplary embodiment, the communication system 36 is a wireless communication system configured to communicate via a wireless local area network (WLAN) using IEEE 802.11 standards or by using cellular data communication. However, additional, or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

In certain embodiments, the communication system 36 is further configured for communication between the sensor system 28, the actuator system 30, one or more controllers (e.g., the controller 34), and/or more other systems and/or devices. For example, the communication system 36 may include any combination of a controller area network (CAN) bus and/or direct wiring between the sensor system 28, the actuator system 30, one or more controllers 34, and/or one or more other systems and/or devices. In various embodiments, the communication system 36 may include one or more transceivers for communicating with one or more devices and/or systems of the vehicle 10, devices of the passengers, and/or one or more sources of remote information (e.g., GPS data, traffic information, weather information, and so on).

The controller 34 includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

In various embodiments, the controller 34 includes one or more components of the lane change negotiation system 100. For example, one or more instructions of the controller, when executed by the processor 44, execute logic of a finite state machine to control the vehicle during a lane change maneuver according to defined lateral targets and safety measures. As can be appreciated, the subject matter disclosed herein provides certain enhanced features and functionality to what may be considered as a standard or baseline vehicle 10 and/or a vehicle based remote transportation system associated with the vehicle 10. To this end, a vehicle and vehicle based remote transportation system can be modified, enhanced, or otherwise supplemented to provide the additional features described in more detail below.

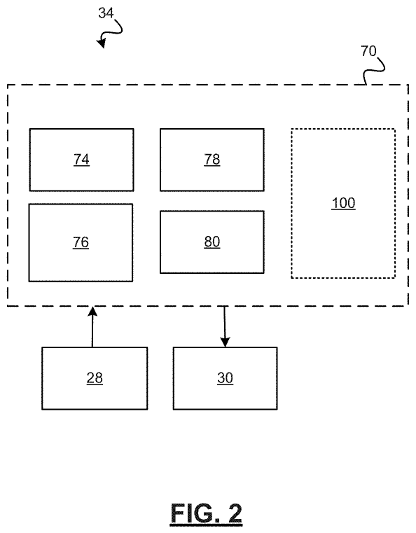

With reference now to FIG. 2, in accordance with various embodiments, the controller 34 implements an autonomous driving system (ADS). That is, suitable software and/or hardware components of the controller 34 (e.g., processor 44 and computer-readable storage device 46) are utilized to provide an ADS that is used in conjunction with vehicle 10.

In various embodiments, the instructions of the autonomous driving system 70 may be organized by function or system. For example, as shown in FIG. 2, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, and the like) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

In various embodiments, as discussed above with regard to FIG. 1, one or more instructions of the controller 34 are embodied in the lane change negotiation system 100, for planning lateral targets and control the movement of the vehicle 10 during left or right lane change maneuvers. All or parts of the lane change negotiation system 100 may be embodied in the guidance system 78, and/or the vehicle control system 80 or may be implemented as a separate system, as shown.

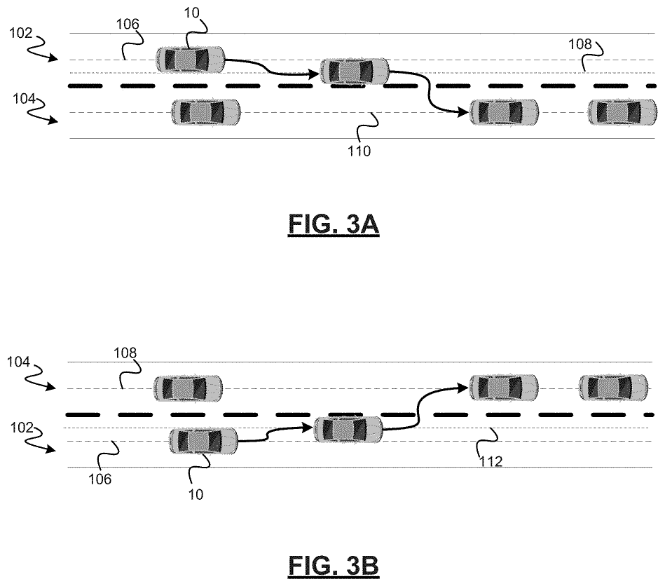

As shown in FIGS. 3A and 3B, the lane change negotiation system 100 includes at least three lateral targets for each lane change direction. In various embodiments, the lateral targets can be determined based on sensor data received from the sensor system of the vehicle 10, map data, and/or parameters indicating a size of the vehicle 10. As shown in FIG. 3A, for a lane change to the right from an initial lane 102 to an intended lane 104, the lateral targets include: a center of initial lane target 106, a negotiation target 108 which is offset to the right of the center of the initial lane 102, and a center of intended lane target 110. In another example, as shown in FIG. 3B, for a lane change to the left from the initial lane 102 to the intended lane 104, the lateral targets include: the center of initial lane target 106, a negotiation target 112 which is offset to the left or right of the center of the initial lane 102, and a center of intended lane target 110. In various embodiments, it is assumed that travelling on the negotiation offsets 108, 112 (and/or moving towards the negotiation offsets 108, 112) signals to other drivers about an intended cut-in maneuver and creates a reaction of the other drivers in the corresponding intended lane 104.

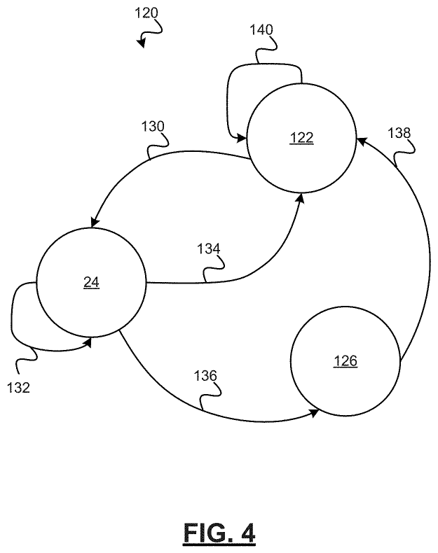

In various embodiments, the vehicle 10 is controlled laterally to any one of the targets 106, 108, 110, 112 at any time, based on logic of a finite state machine. As shown in FIG. 4, an exemplary finite state machine 120 includes at least three states 122-126 and a plurality of transitions 130-140. In various embodiments, the states include an initial lane centering state 122, a negotiation state 124, and an intended lane centering state 126. When in the initial lane centering state 122, the vehicle 10 is controlled to the center of initial lane target 106. When in the negotiation state 124, the vehicle 10 is controlled to the negotiation target 108, 112 that is in the direction of the lane change. When in the intended lane centering state 126, the vehicle 10 is controlled to the center of the intended lane target 110.

Transitioning from the initial lane centering state 122 to the negotiation state 124 at transition 130 and staying in the negotiation state 124 at transition 132 is assumed to trigger a reaction of other drivers in the intended lane 104 (e.g., yield, slow-down with some probability, etc.). The vehicle 10 can be controlled to stay in the negotiation state 124 for an unlimited time. The vehicle 10 transitions from the negotiation state 124 back to the initial lane centering state 122 at transition 134 can occur when it is determined that the lane change is no longer desired (e.g., change in route planning according to human driver feedback or any external feedback to the system). This transition can be referred to as “aborting” the lane change. Transitioning from the negotiation state 124 to the intended lane centering state 126 occurs at transition 136 when it is determined that the vehicle 10 can commit to execute the lane change to completion safely. Once the intended lane centering state 126 is active and a complete lane change has been fully executed with the vehicle 10 at the center of the intended lane target 110, the vehicle 10 is transitioned back to the initial lane centering state 122 at 138. The vehicle 10 is maintained in the initial lane centering state 122 at transition 140 until a lane change is desired again.

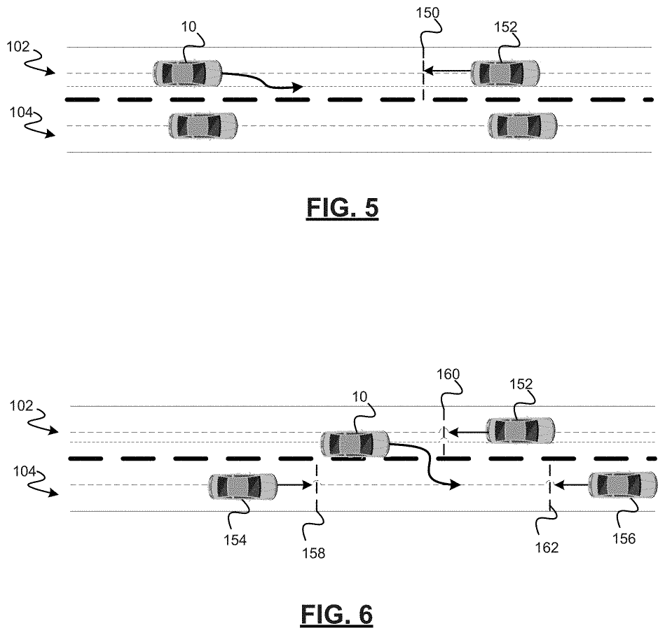

In various embodiments, while in the initial lane centering state 122, transitioning to the negotiation state 124, and in the negotiation state 124, safety is maintained with respect to other vehicles in the initial lane 104 since the vehicle 10 still lies in the initial lane 104 and does not interfere with traffic in the target lane. For example, as shown in FIG. 5, future lateral motion plans of the vehicle 10 are validated by computing a safety distance 150 with respect to a leading vehicle 152 in the initial lane 102. The vehicle 10 is controlled to perform the lateral movement prior to the computed safety distance 150. In various embodiments, the safety distance is computed based on a summation of the vehicle 10 distance travelled before reacting, and the vehicle 10 distance travelled while acting (braking), minus the vehicle 152 distance travelled while braking. In various embodiments, the distances are based on velocities of the respective vehicles.

As discussed above, transitioning from the negotiation state 124 to the intended lane centering state 126 at transition 136 is allowed only when the lane change can be verified for safety until completion. The verification is performed ahead of execution of the lane change and requires taking more pro-active measures.

For example, as shown in FIG. 6, safety is maintained with respect to three possible vehicles. The vehicles include a vehicle 154 in the intended lane 104 in which the vehicle 10 intends to cut-in in front of, a vehicle 156 in the intended lane 104 in which the vehicle 10 intends to cut-in in back of, and the vehicle 152 in the initial lane 102 in which the vehicle 10 is travelling behind. Future lateral motion plans of the vehicle 10 are validated by computing a safety distance 150 with respect to any detected vehicle of the three possible vehicles 152, 154, and 156.

When evaluating safety against the vehicle 154, a safety distance 158 is computed based on a predicted time when the cut-in should occur (t_cut), a predicted state of the vehicle 10 and a predicted state of the vehicle 154 at the expected time of cut-in (t_cut), with ro>0 to account for the time delay it takes the vehicle 154 to detect the cut-in. In various embodiments, the state of the vehicle 154 is predicted using a worst-case prediction model; and the state of the vehicle 10 is predicted using a sample from the future motion plan at t_cut. Note that this requires that the vehicle 10 will accurately follow the motion plan at least until time (t_cut) with no deviations. The vehicle 10 is controlled to perform the lateral movement after the computed safety distance 158.

When evaluating safety against the vehicle 152, a safety distance 160 is computed based on a predicted state at a future time (t+dt). Here, safety validations are performed from current time t up to time t+dt where dt stands for the time between planning-iterations. For instance, if planning is executed every one second, then dt=1 [sec]. In various embodiments, the state of the vehicle 10 is predicted using a sample from the future motion plan at times in the range t to t+dt. Thereafter, the vehicle 10 is controlled to perform the lateral movement prior to the computed safety distance 160.

When evaluating safety against the vehicle 156, a safety distance 162 is similarly computed based on a predicted state at a maximum of the future time and the predicted time to cut-in mas(t+dt, t_cut) to facilitate the requirement above of tracking the motion plan accurately at least until t_cut. The vehicle 10 is controlled to perform the lateral movement prior to the computed safety distance 162.

To allow the vehicle 10 to safely react to changes in the states of vehicles 152 and 156 while in the intended lane centering state, the last two conditions are tested according to detected lane-occupancy of the vehicle 10. In various embodiments, the availability of the lane change maneuver depends on the time to cut-in (t_cut−t). By setting the negotiation target close to the lane's boundary reduces the time to cut-in when evaluating lane change safety conditions and increases availability.

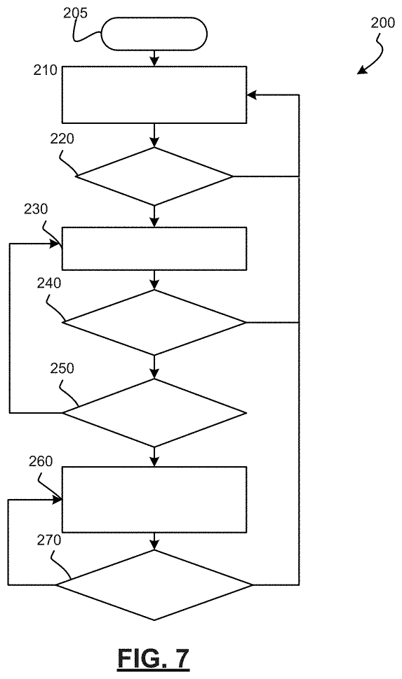

With reference to FIG. 7 and with continued reference to FIG. 1-6, a flowchart is provided for a control process 200 for planning a lane change along a roadway. In accordance with various embodiments, the control process 200 can be implemented in connection with the lane change negotiation system 100 and vehicle 10 of FIG. 1, the autonomous driving system of FIG. 2, and the finite state machine of FIG. 4. As can be appreciated in light of the disclosure, the order of operation within the control process 200 is not limited to the sequential execution as illustrated in FIG. 7 but may be performed in one or more varying orders as applicable and in accordance with the present disclosure. In various embodiments, the control process 200 can be scheduled to run based on one or more predetermined events, and/or can run continuously during operation of the vehicle 10.

In one example, the control process 200 may begin at 205. The vehicle 10 is controlled to the initial lane center target 106 at 210, Thereafter, it is determined whether a lane change is desired at 220. When a lane change is not desired at 220, the process 200 continues with controlling the vehicle 10 to the initial lane center target 106 at 210.

When a lane change is desired at 220, the vehicle 10 is controlled laterally to or near the negotiation target 108 or 112 at 220. Thereafter, it is determined, while travelling at the negotiation offset 108 or 112, whether the lane change is still desired at 240. When the lane change is no longer desired at 240, the process 200 continues with controlling the vehicle 10 to the initial lane center target 106 at 210.

When a lane change is still desired at 240, it is determined whether the full lane change is safe at 250. When it is determined that the full lane change is not safe at 250, the process 200 continues with controlling the vehicle 10 laterally to or near the negotiation target 108 or 112 at 220. When it is determined that the full lane change is safe at 250, the vehicle 10 is controlled laterally to the intended lane center target 110 at 260. If the vehicle 10 is not yet assigned to the intended lane 104 at 270, the process 200 continues with controlling the vehicle 10 laterally to the intended lane center target 110 at 260. Once the vehicle 10 is assigned to the intended lane 104, the process 200 continues with controlling the vehicle 10 laterally to the new initial lane center target 106 at 210.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for executing a lane change for a host vehicle, comprising:
receiving, by a processor, an indication that a lane change from an initial lane to an intended lane is desired for the host vehicle;
defining, by the processor, an initial lane center target, a negotiation target, and an intended lane center target based on the desired lane change; and
controlling, by the processor, the host vehicle to at least one of the initial lane center target, the negotiation target, and the intended lane center target based on a finite state machine,
wherein the initial lane center target is at or in proximity to a determined center of the initial lane, wherein the intended lane center target is at or in proximity to a determined center of the intended lane, and wherein the negotiation target is offset from the initial lane center target and within the initial lane.

2. The method of claim 1, wherein the determining the negotiation target is based on sensor data received from sensors of the host vehicle.

3. The method of claim 1, wherein the determining the negotiation target is based on vehicle parameters defining the size of the host vehicle.

4. The method of claim 1, wherein the determining the negotiation target is based on a desired right lane change and a desired left lane change.

5. The method of claim 1, wherein the finite state machine includes at least three states, an initial lane centering state, a negotiation state, and an intended lane centering state, and wherein the method comprises:
controlling, by the processor, the host vehicle to the initial lane center target when a current state is the initial lane centering state;
controlling, by the processor, the host vehicle to the negotiation target when the current state is the negotiation state; and
controlling, by the processor, the host vehicle to the intended lance center target when the current state is the intended lane centering state.

6. The method of claim 1, wherein the finite state machine includes a plurality of transitions, wherein at least one of the transitions is based on a safety distance associated with an other.

7. The method of claim 6, further comprising determining the other vehicle to be within the initial lane and ahead of a position of the host vehicle.

8. The method of claim 6, further comprising determining the other vehicle to be within the intended lane behind or at a position of the host vehicle.

9. The method of claim 6, further comprising determining the other vehicle to be within the intended lane and ahead of a position of the host vehicle.

10. The method of claim 6, further comprising computing the safety distance based on a predicted state of the other vehicle at a future time.

11. The method of claim 10, further comprising computing the safety distance based on the predicted state of the other vehicle at the future time and until the future time is equal to a predicted time of cut-in to the intended lane.

12. The method of claim 6, further comprising computing the safety distance based on a predicted time of cut-in to the intended lane, a predicted state of the host vehicle at the predicted time of cut-in, and a predicted state of the other vehicle at the predicted time of cut-in.

13. A system for executing a lane change for a host vehicle, comprising:
one or more sensors configured to obtain sensor data pertaining to a host vehicle and one or more other vehicles in proximity to the host vehicle; and
a processor coupled to the one or more sensors and configured to:
receive an indication that a lane change from an initial lane to an intended lane is desired for the host vehicle;
define an initial lane center target, a negotiation target, and an intended lane center target based on the desired lane change; and
control the host vehicle to at least one of the initial lane center target, the negotiation target, and the intended lane center target based on a finite state machine,
wherein the initial lane center target is at or in proximity to a determined center of the initial lane, wherein the intended lane center target is at or in proximity to a determined center of the intended lane, and wherein the negotiation target is offset from the initial lane center target and within the initial lane.

14. The system of claim 13, the negotiation target is determined based on at least one of the sensor data, vehicle parameters defining the size of the host vehicle, a desired right lane change and a desired left lane change.

15. The system of claim 13, wherein the finite state machine includes at least three states, an initial lane centering state, a negotiation state, and an intended lane centering state, and
wherein when a current state is the initial lane centering state, the processor controls the host vehicle to the initial lane center target,
wherein when the current state is the negotiation state, the processor controls the host vehicle to the negotiation target, and
when the current state is the intended lane centering state, the processor controls the host vehicle to the intended lance center target.

16. The system of claim 13, wherein the finite state machine includes a plurality of transitions, wherein at least one of the transitions is based on a safety distance associated with an other.

17. The system of claim 16, wherein the processor is further configured to: compute the safety distance based on a predicted state of the other vehicle at a future time.

18. The system of claim 17, wherein the processor is further configured to: Compute the safety distance based on the predicted state of the other vehicle at the future time and until the future time is equal to a predicted time of cut-in to the intended lane.

19. The system of claim 16, wherein the processor is further configured to: compute the safety distance based on a predicted time of cut-in to the intended lane, a predicted state of the host vehicle at the predicted time of cut-in, and a predicted state of the other vehicle at the predicted time of cut-in.

20. An autonomous vehicle, comprising:
one or more sensors configured to obtain sensor data pertaining to the autonomous vehicle and one or more other vehicles in proximity to the autonomous vehicle; and
a processor coupled to the one or more sensors and configured to:
receive an indication that a lane change from an initial lane to an intended lane is desired for the autonomous vehicle;
define an initial lane center target, a negotiation target, and an intended lane center target based on the desired lane change; and
control the autonomous vehicle to at least one of the initial lane center target, the negotiation target, and the intended lane center target based on a finite state machine,
wherein the initial lane center target is at or in proximity to a determined center of the initial lane, wherein the intended lane center target is at or in proximity to a determined center of the intended lane, and wherein the negotiation target is offset from the initial lane center target and within the initial lane.
